(19) United States
(12) Patent Application Publication
(10) Pub. No.: US 2024/0313417 A1
(43) Pub. Date: Sep. 19, 2024

(54) CORNER REFLECTOR INSTALLATION STRUCTURE

(71) Applicant: HONDA MOTOR CO., LTD., Tokyo (JP)

(72) Inventors: Koji HANAI, Tokyo (JP); Tsuyoshi OGUCHI, Tokyo (JP)

(21) Appl. No.: 18/596,645

(22) Filed: Mar. 6, 2024

(30) Foreign Application Priority Data
Mar. 17, 2023 (JP) 2023-042797

(51) Int. Cl. H01Q 15/18; B62J 6/20; H01Q 1/32

(52) U.S. Cl. CPC H01Q 15/18; B62J 6/20; H01Q 1/32

(57) ABSTRACT

In a corner reflector installation structure that is applicable to a vehicle including: a lamp; a cover member that covers a part of the lamp; and a corner reflector, the corner reflector is provided inside a housing constituting the lamp. The corner reflector installation structure is configured such that that the cover member and the corner reflector overlap with each other in a front view of a vehicle body. The cover member is inclined such that a vehicle body upper side of the cover member is located backward relative to a vehicle body lower side of the cover member in a side view of the vehicle. The cover member is inclined such that a vehicle body lower side of the cover member is located backward relative to a vehicle body upper side of the cover member in a side view of the vehicle.

This application is based on and claims the benefit of priority from Japanese Patent Application No. 2023-042797, filed on 17 Mar. 2023, the content of which is incorporated herein by reference.

### BACKGROUND OF THE INVENTION

### Field of the Invention

The present invention relates to a corner reflector installation structure, and particularly to a corner reflector installation structure that is applicable to a vehicle including a corner reflector that reflects radio waves and the like in an arrival direction in which the radio waves and the like arrive.

### Related Art

In the related art, a configuration has been known in which a corner reflector that includes three reflection plates and reflects radio waves and the like in the arrival direction is attached to parts of a vehicle.

Japanese Unexamined Patent Application, Publication No. 2019-1462 discloses a configuration in which a corner reflector is installed inside a headlight unit of a motorcycle. According to this configuration, it is possible to prevent deterioration of reflection performance for reflecting radio waves and the like that can be caused by adhesion of moisture, dust, and the like to the corner reflector.
Patent Document 1: Japanese Unexamined Patent Application, Publication No. 2019-1462

### SUMMARY OF THE INVENTION

However, in a case where the corner reflector is installed inside a lamp such as a headlight or a taillight, appearance of a vehicle may deteriorate if the corner reflector is visually recognized from outside. In this regard, Japanese Unexamined Patent Application, Publication No. 2019-1462 does not give consideration to a specific structure indicating how the corner reactor should be disposed inside the lamp. The present invention has been achieved in order to improve visibility of a vehicle by a corner reflector. This also further improves transportation safety and contributes to development of a sustainable transportation system.

An object of the present invention is to solve the aforementioned problem in the related art and to provide a corner reflector installation structure that allows the corner reflector to be installed inside a lamp without affecting appearance.

In order to achieve the above object, the present invention has a first feature in which a corner reflector installation structure that is applicable to a vehicle (1) including: a lamp (20); a cover member (5, 19) that covers a part of the lamp (20); and a corner reflector (CR). The corner reflector (CR) is provided inside a housing (H) constituting the lamp (20), and the corner reflector installation structure is configured such that the cover member (5, 19) and the corner reflector (CR) overlap with each other in a front view of a vehicle body of the vehicle (1).

The present invention has a second feature in which the cover member (5) is inclined such that a vehicle body upper side of the cover member (5) is located backward relative to a vehicle body lower side of the cover member (5) in a side view of the vehicle.

The present invention has a third feature in which the cover member (19) is inclined such that a vehicle body lower side of the cover member (19) is located backward relative to a vehicle body upper side of the cover member (19) in a side view of the vehicle.

The present invention has a fourth feature in which a substrate (30) on which components including metal are mounted is provided inside the housing (H), and the corner reflector (CR) is installed such that the corner reflector (CR) does not overlap with the substrate (30) and partially overlaps with an outside of a range of a height dimension (h) of the substrate (30) in a front view of the vehicle body.

The present invention has a fifth feature in which a substrate (30) on which components including metal are mounted is provided inside the housing (H), and the corner reflector (CR) is installed such that the corner reflector (CR) does not overlap with the substrate (30) and is within a range of a height dimension (h) of the substrate (30) in a front view of the vehicle body.

The present invention has a sixth feature in which a substrate (30) on which components including metal are mounted is provided inside the housing (H), and the corner reflector (CR) is installed such that the corner reflector (CR) does not overlap with the substrate (30) and partially overlaps with an outside of a range of a width dimension (w) of the substrate (30) in a front view of the vehicle body.

The present invention has a seventh feature in which a substrate (30) on which components including metal are mounted is provided inside the housing (H), and the corner reflector (CR) is installed such that the corner reflector (CR) does not overlap with the substrate (30) and is within a range of a width dimension (w) of the substrate (30) in a front view of the vehicle body.

The present invention has an eighth feature in which a substrate (30) on which components including metal are mounted is provided inside the housing (H), and the corner reflector (CR) is disposed forward relative to the substrate (30).

The present invention has a ninth feature in which a substrate (30) on which components including metal are mounted is provided inside the housing (H), and the corner reflector (CR) is integrated with the substrate (30) or is coupled to the substrate (30) via a metal member.

The present invention has a tenth feature in which the lamp (20) has a heat sink (50), and the corner reflector (CR) is integrated with the heat sink (50) or is coupled to the heat sink (50) via a metal member.

The present invention has an eleventh feature in which a substrate (30) on which components including metal are mounted is provided inside the housing (H), a noise shield (60) covers at least a part of the substrate (30), the noise shield (60) has an opening (61) in a front portion thereof, and the corner reflector (CR) is disposed in front of the opening (61).

The present invention has a twelfth feature in which a substrate (30) on which components including metal are mounted is provided inside the housing (H), a noise shield (60) covers at least a part of the substrate (30), and the corner reflector (CR) is integrated with the noise shield (60) or is coupled to the noise shield (60) via a stay member.

Furthermore, the present invention has a thirteenth feature in which a light guiding member (90) that emits light from an entire body thereof by causing irradiation light from a light source (L) to be incident thereon is provided inside the housing (H), and the corner reflector (CR) is provided behind the light guiding member (90).

According to the first feature, in which, in the corner reflector installation structure that is applicable to the vehicle (1) including: the lamp (20); the cover member (5, 19) that covers a part of the lamp (20); and the corner reflector (CR), the corner reflector (CR) is provided inside the housing (H) constituting the lamp (20), and the corner reflector installation structure is configured such that the the cover members (5, 19) and the corner reflector (CR) overlap with each other in a front view of the vehicle body, it is possible to prevent deterioration of reflection performance for reflecting radio waves and the like that can be caused by adhesion of moisture, mud, and the like to the corner reflector, and it is possible to prevent deterioration of appearance of the vehicle because the corner reflector is not visually recognized from outside.

According to the second feature, in which the cover member (5) is inclined such that the vehicle body upper side of the cover member (5) is located backward relative to the vehicle body lower side of the cover member (5) in a side view of the vehicle, mud splashed up from a road surface is unlikely to adhere to the cover member, and water, mud, or the like are likely to flow toward the upper rear side due to wind during traveling even in a case where water, mud, or the like adheres to the cover member, thereby making it possible to prevent deterioration of reflection performance of the corner reflector.

According to the third feature, in which the cover member (19) is inclined such that the vehicle body lower side of the cover member (19) is located backward relative to the vehicle body upper side of the cover member (19) in a side view of the vehicle, water, mud, or the like is likely to flow toward the lower rear side due to influences of gravity and wind during traveling even in a case where water, mud, or the like adheres to the cover member, thereby making it possible to prevent deterioration of reflection performance of the corner reflector.

According to the fourth feature, in which the substrate (30) on which components including metal are mounted is provided inside the housing (H), and the corner reflector (CR) is installed such that the corner reflector (CR) does not overlap with the substrate (30) and partially overlaps with an outside of the range of the height dimension (h) of the substrate (30) in a front view of the vehicle body, it is possible to maintain reflection performance of the corner reflector and to prevent an increase in dimension of the lamp in the up-down direction.

According to the fifth feature, in which the substrate (30) on which components including metal are mounted is provided inside the housing (H), and the corner reflector (CR) is installed such that the corner reflector (CR) does not overlap with the substrate (30) and is within the range of the height dimension (h) of the substrate (30) in a front view of the vehicle body, it is possible to maintain reflection performance of the corner reflector and to further prevent an increase in dimension of the lamp in the up-down direction.

According to the sixth feature, in which the substrate (30) on which components including metal are mounted is provided inside the housing (H), and the corner reflector (CR) is installed such that the corner reflector (CR) does not overlap with the substrate (30) and partially overlaps with an outside of the range of the width dimension (w) of the substrate (30) in a front view of the vehicle body, it is possible to maintain reflection performance of the corner reflector and to prevent an increase in dimension of the lamp in the left-right direction.

According to the seventh feature, in which the substrate (30) on which components including metal are mounted is provided inside the housing (H), and the corner reflector (CR) is installed such that the corner reflector (CR) does not overlap with the substrate (30) and is within the range of the width dimension (w) of the substrate (30) in a front view of the vehicle body, it is possible to maintain reflection performance of the corner reflector and to further prevent an increase in dimension of the lamp in the left-right dimension.

According to the eighth feature, in which the substrate (30) on which components including metal are mounted is provided inside the housing (H), and the corner reflector (CR) is disposed forward relative to the substrate (30), it is possible to enhance a degree of freedom in installing the corner reflector in a space located forward relative to the substrate and to enhance reflection performance of the corner reflector. In addition, disposing the corner reflector at a position forward relative to the substrate prevents the components including metal mounted on the substrate from affecting the reflection performance of the corner reflector.

According to the ninth feature, in which the substrate (30) on which components including metal are mounted is provided inside the housing (H), and the corner reflector (CR) is integrated with the substrate (30) or is coupled to the substrate (30) via the metal member, it is possible to curb a rise of heat of the substrate by using the corner reflector serving as a heat dissipation member and coupled to the substrate since.

According to the tenth feature, in which the lamp (20) has a heat sink (50), and the corner reflector (CR) is integrated with the heat sink (50) or is coupled to the heat sink (50) via the metal member, it is possible to curb a rise of heat of the heat sink by using the corner reflector serving as a heat dissipation member and coupled to the heat sink since.

According to the eleventh feature, in which the substrate (30) on which components including metal are mounted is provided inside the housing (H), the noise shield (60) covers at least a part of the substrate (30), the noise shield (60) has an opening (61) in a front portion thereof, and the corner reflector (CR) is disposed in front of the opening (61), it is possible to block noise of the substrate dissipated forward from the opening of the noise shield with the corner reflector.

According to the twelfth feature, in which the substrate (30) on which components including metal are mounted is provided inside the housing (H), the noise shield (60) covers at least a part of the substrate (30), and the corner reflector (CR) is integrated with the noise shield (60) or is coupled to the noise shield (60) via the stay member, it is possible to eliminate the need for providing a member for supporting the corner reflector or to reduce the size of the member.

According to the thirteenth feature, in which the light guiding member (90) that emits light from an entire body thereof by causing irradiation light from a light source (L) to be incident thereon is provided inside the housing (H), and the corner reflector (CR) is provided behind the light guiding member (90), it is possible to install the corner reflector in a space provided behind the light guiding member.

Specifically, since it is necessary to ensure a certain distance between the light source and the light guiding member in order to cause the irradiation light from the light source to be incident on the light guiding member, a space is formed behind the light guiding member, and the corner reflector can be disposed by effectively using the space.

### BRIEF DESCRIPTION OF THE DRAWINGS

FIG. 1 is a left side view of a motorcycle according to a present embodiment;

FIG. 2 is a front view of the motorcycle;

FIG. 3 is a perspective view of a headlight unit;

FIG. 4 is a perspective view of a corner reflector of a type 1;

FIG. 5 is a perspective view of a corner reflector of a type 2;

FIG. 6 is a schematic sectional view corresponding to a sectional view along the line VI-VI in FIG. 2;

FIG. 7 is a schematic diagram illustrating a corner reflector installation structure according to a second embodiment of the present invention;

FIG. 8 is a front view illustrating a disposition relationship between a substrate and a corner reflector according to a modification of the present invention;

FIG. 9 is a front view illustrating a disposition relationship between a substrate and a corner reflector according to a second modification of the present invention;

FIG. 10 is a sectional view illustrating a disposition relationship between a substrate and a corner reflector according to a third modification of the present invention;

FIG. 11 is a sectional view illustrating a disposition relationship between a heat sink and the corner reflector according to the second embodiment of the present invention;

FIG. 12 is a sectional view illustrating a disposition relationship between a noise shield and a corner reflector according to a third embodiment of the present invention;

FIG. 13 is a sectional view illustrating a disposition relationship between a noise shield and a corner reflector according to a modification of the third embodiment of the present invention; and

FIG. 14 is a perspective view illustrating a corner reflector installation structure according to a fourth embodiment of the present invention.

### DETAILED DESCRIPTION OF THE INVENTION

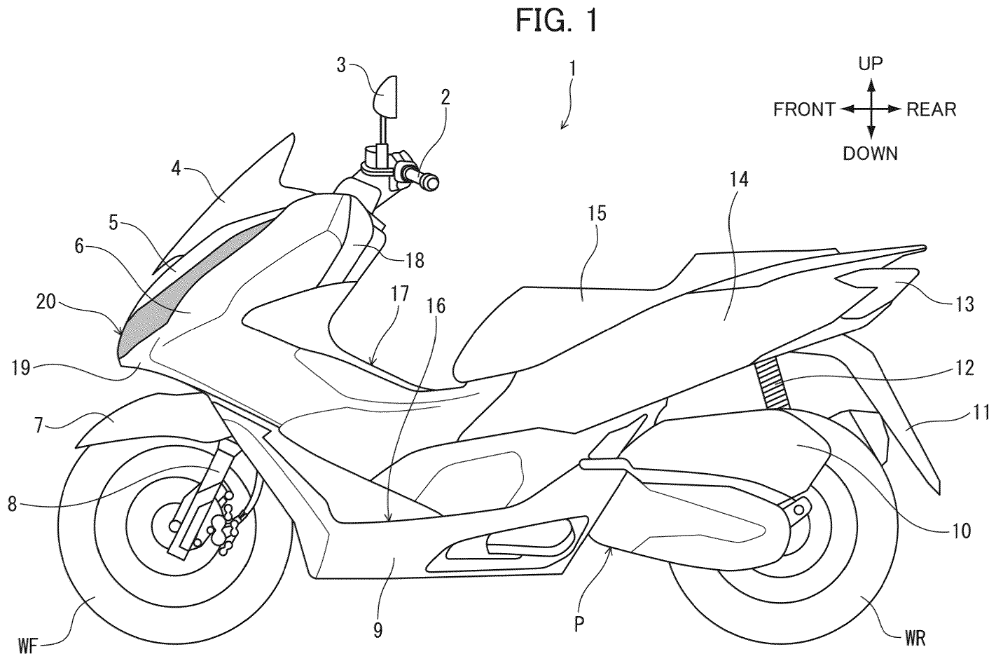

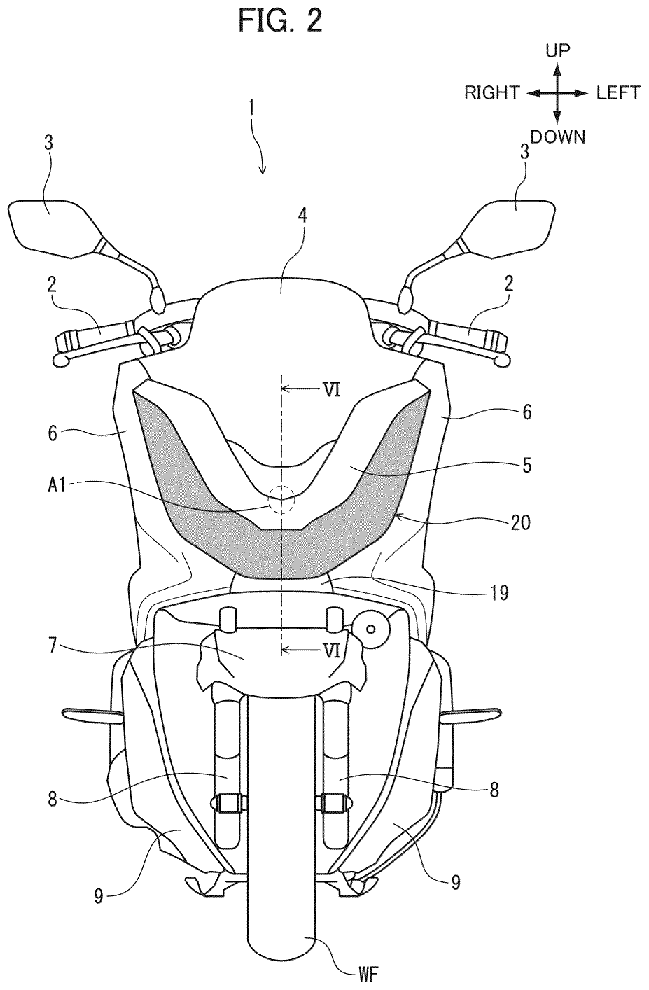

Preferred embodiments of the present invention will be described in detail with reference to the drawings. FIG. 1 is a left side view of a motorcycle 1 to which a corner reflector installation structure according to a present embodiment is applied. Also, FIG. 2 is a front view of the motorcycle 1. The motorcycle 1 is a scooter-type straddle-type vehicle in which a straddle portion 17 provided to stand at a center in a vehicle width direction and a pair of left and right footrest floors 16 are provided between steering handlebars 2 and a seat 15.

A pair of left and right front forks 8 that axially support a front wheel WF in a turnable manner are supported in a steerable manner at a front portion of the motorcycle 1. A unit swing-type power unit P in which an engine and a continuously variable transmission are integrally configured is supported in a vertically swingable manner at a rear portion of the motorcycle 1. A rear portion of the power unit P is suspended from a vehicle body by a rear cushion 12, and a rear wheel WR is axially supported in a rotatable manner at a rear end of the power unit P. An air cleaner box 10 is fixed to an upper portion of the power unit P.

A leg shield 18 facing legs of a driver is disposed below the steering handlebars 2 supporting rearview mirrors 3. A pair of left and right side cowls 6 are coupled to left and right ends of the leg shield 18. A headlight unit 20 as a lamp is disposed between the left and right side cowls 6. A light emitting surface (the gray color part in the drawing) of the headlight unit 20 has a substantially U shape extending left and right from a center in a vehicle width direction and then extending upward in a front view of the vehicle body. A front cowl 5 as a cover member is disposed above the headlight unit 20, and a windproof screen 4 is disposed above the front cowl 5. Also, a coupling cowl 19 as a cover member coupling the left and right side cowls 6 is disposed below the headlight unit 20.

Under cowls 9 extending downward from outer ends of the footrest floors 16 in the vehicle width direction are attached to lower portions of the side cowls 6, and seat cowls 14 supporting the seat 15 are coupled to rear portions of the side cowls 6. A rear position lamp device 13 as a lamp is attached to rear ends of the seat cowls 14, and a rear fender 11 located on a rear upper side of the rear wheel WR is disposed below the rear position lamp device 13. A front fender 7 covering an upper side of the front wheel WF is attached to the front forks 8.

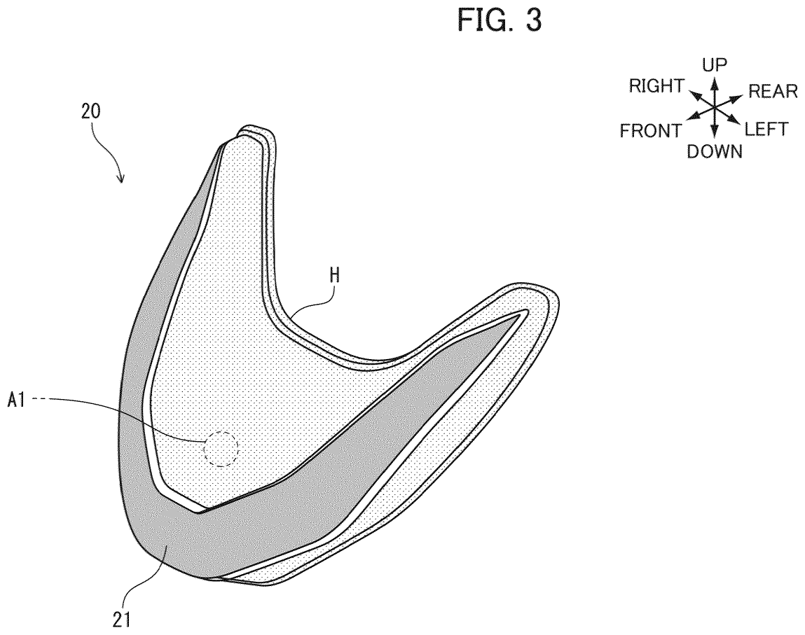

FIG. 3 is a perspective view of the headlight unit 20. An outer shell of the headlight unit 20 is configured by a housing H (the dot-hatched part in the drawing) accommodating a substrate with a light source mounted thereon, a reflector that reflects irradiation light of the light source forward, and the like and an outer lens 21 that puts a lid on the housing H from the front side. The housing H is formed by a colored synthetic resin or the like, and the outer lens 21 is formed by a clear transparent synthetic resin or the like.

The present invention relates to a structure in which a corner reflector including three reflection plates and reflecting radio waves and the like in an arrival direction thereof is disposed inside the housing H of the lamp. The corner reflector can be disposed inside the housing H at the center in the vehicle width direction as illustrated by the dashed-line circle A1 in FIGS. 2 and 3, for example. The position where the corner reflector is disposed is not limited to the position indicated by the dashed-line circle A1 and can be moved in up-down, left-right, and front-rear directions within a range in which conditions of the present invention can be satisfied.

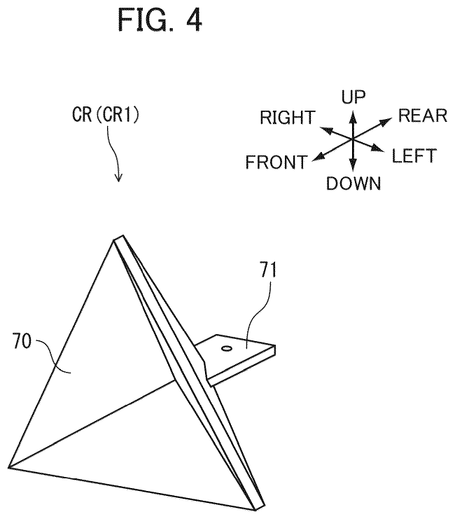

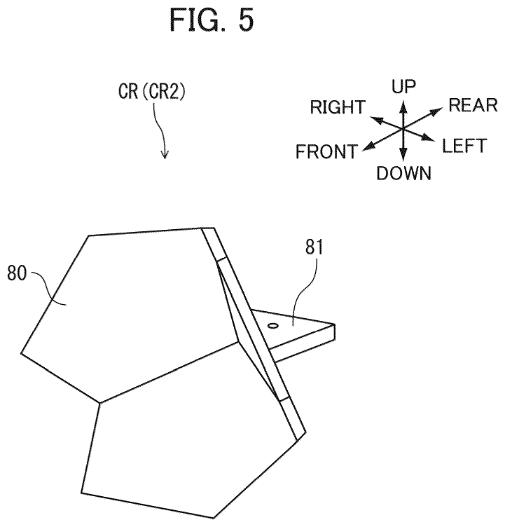

FIG. 4 is a perspective view of a corner reflector CR1 of a type 1. Also, FIG. 5 is a perspective view of a corner reflector CR2 of a type 2. Although there are corner reflectors CR formed of a plated hard resin or the like to have various shapes and sizes, the corner reflectors CR similarly have a function of reflecting radio waves and the like in an arrival direction thereof. Both the corner reflector CR1 and the corner reflector CR2 have a configuration in which attachment stays 71, 81 are provided at rear portions of main bodies 70, 80 that reflect radio waves and the like. The shapes of the attachment stays 71, 81 can be changed in various manners. Hereinafter, the corner reflector CR will be schematically illustrated by a triangle regardless of differences between the aforementioned types.

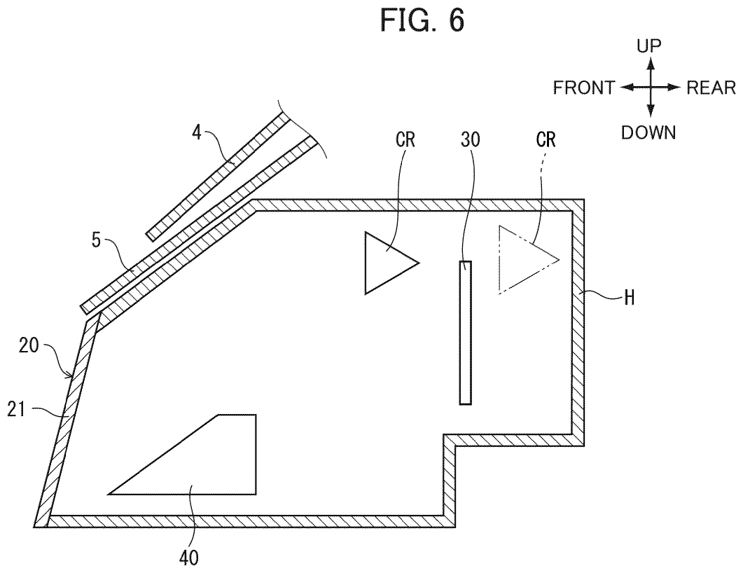

FIG. 6 is a schematic sectional view corresponding to a sectional view along the line VI-VI in FIG. 2. A reflector 40 that reflects irradiation light of the light source forward is disposed at a lower portion near the front side of the housing H, and a substrate 30 on which elements, wirings, and the like such as a light emitting diode and a resistor are mounted is disposed at a position near a rear portion of the housing H. The corner reflector CR is disposed at a position behind the front cowl 5 as a cover member. In this manner, the corner reflector CR is configured not to be visually recognized from outside by a part of the headlight unit 20 being covered with the front cowl 5 in the present embodiment. More specifically, the front cowl 5 and the corner reflector CR are configured to overlap with each other in a front view of the vehicle body. This can prevent deterioration of reflection performance for reflecting radio waves and the like that can be caused due to adhesion of moisture, mud, and the like to the corner reflector CR, and prevent deterioration of appearance of the vehicle because the corner reflector CR is not visually recognized from outside.

Also, the corner reflector CR is provided at a position above the center of the headlight unit 20 in the up-down direction, and the front cowl 5 is inclined such that a vehicle body upper side of the front cowl 5 is located backward relative to a vehicle body lower side of the front cowl 5 in a side view of the vehicle, in the present embodiment. In this manner, mud splashed up from a road surface becomes unlikely to adhere to the front cowl 5, and it is possible to prevent deterioration of reflection performance of the corner reflector CR since water, mud, or the like are likely to flow on the upper rear side due to wind during traveling even in a case where water, mud, or the like adheres to the front cowl 5.

Installing the corner reflector CR being at a position forward relative to the substrate 30 makes it possible to enhance a degree of freedom in installing the corner reflector CR in a space located forward relative to the substrate 30 and to enhance reflection performance of the corner reflector CR. The substrate 30 is typically made of a synthetic resin, and elements and wirings as components mounted on the substrate 30 include metal. Since such metal affects reflection performance for reflecting radio waves and the like if the metal is present in front of the corner reflector CR, the corner reflector CR is preferably disposed in front of the substrate 30. Note that in a case where influences on the reflection performance are small, the corner reflector CR may be disposed behind the substrate 30.

Furthermore, although the reflector 40 may be configured of a plated synthetic resin or may be configured of metal such as aluminum in some cases, and presence of metal components in front of the corner reflector CR affects the reflection performance for reflecting radio waves and the like, the reflection performance is not affected in the present embodiment since no metal components are present in front of the corner reflector CR.

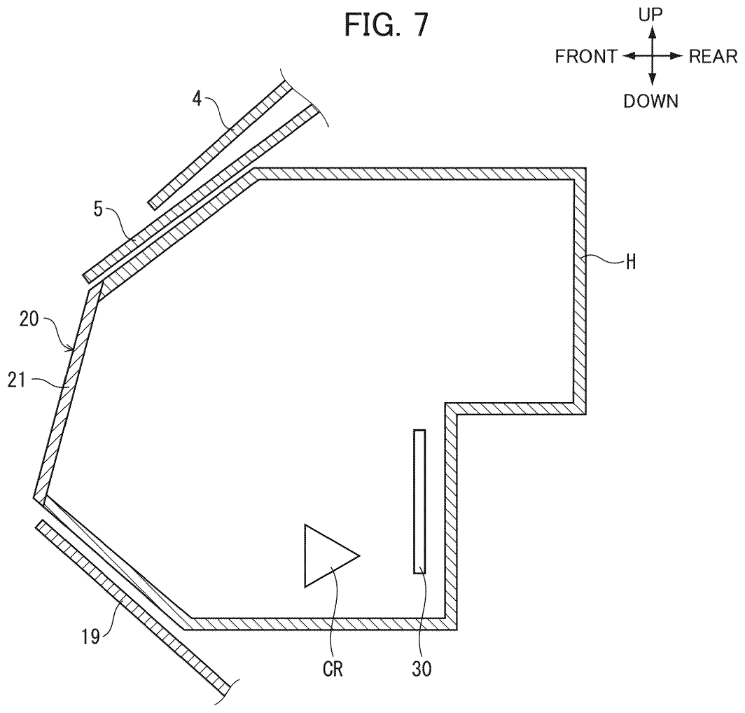

FIG. 7 is a schematic diagram illustrating a corner reflector installation structure for a corner reflector CR according to a second embodiment of the present invention. In the present embodiment, a housing H is extended in its portion below an outer lens 21, and a substrate 30 and the corner reflector CR are disposed in the extended part. A coupling cowl 19 as a cover member as described above is disposed in front of the housing H extended downward. With this configuration, the corner reflector CR is provided at a position below the center of the headlight unit 20 in the up-down direction, the coupling cowl 19 is inclined such that the vehicle body lower side of the coupling cowl 19 is located backward relative to the vehicle body upper side of the coupling cowl 19 in a side view of the vehicle, water, mud, or the like is thus likely to flow on the lower rear side due to influences of gravity and wind during traveling even in a case where water, mud, or the like adheres to the coupling cowl 19, and it is possible to prevent deterioration of the reflection performance of the corner reflector CR.

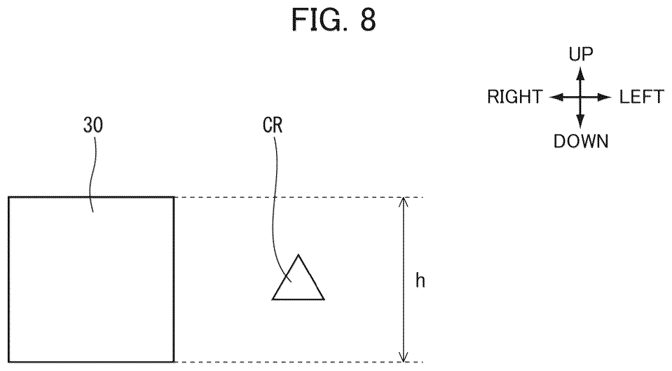

FIG. 8 is a front view illustrating a disposition relationship between the substrate 30 and the corner reflector CR according to a modification of the present invention. The corner reflector CR can be installed such that the corner reflector CR does not overlap with the substrate 30 and is within a range of a height dimension h of the substrate 30 in a front view of the vehicle body. It is thus possible to maintain the reflection performance of the corner reflector CR and to prevent an increase in dimension of the headlight unit 20 in the up-down direction. Note that the corner reflector CR may be installed such that the corner reflector CR does not overlap with the substrate 30 and partially overlaps with an outside of a range of a height dimension h of the substrate 30 in a front view of the vehicle body.

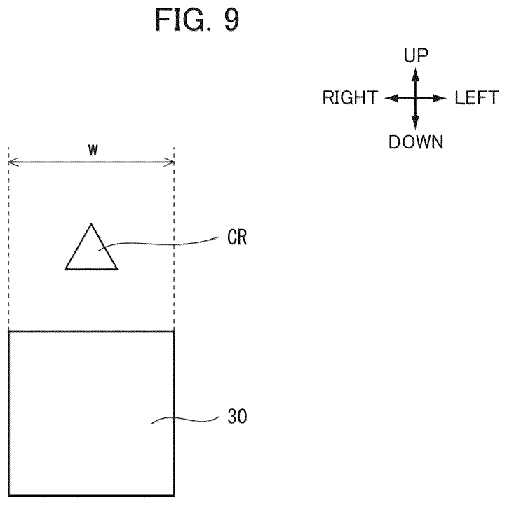

FIG. 9 is a front view illustrating a disposition relationship between the substrate 30 and the corner reflector CR according to a second modification of the present invention. The corner reflector CR can be installed such that the corner reflector CR does not overlap with the substrate 30 and is within a range of a width dimension w of the substrate 30 in a front view of the vehicle body. In this manner, it is possible to maintain the reflection performance of the corner reflector CR and to prevent an increase in dimension of the headlight unit 20 in the left-right direction. Note that the corner reflector CR may be installed such that the corner reflector CR does not overlap with the substrate 30 and partially overlaps with an outside of the range of the width dimension w of the substrate 30 in a front view of the vehicle body.

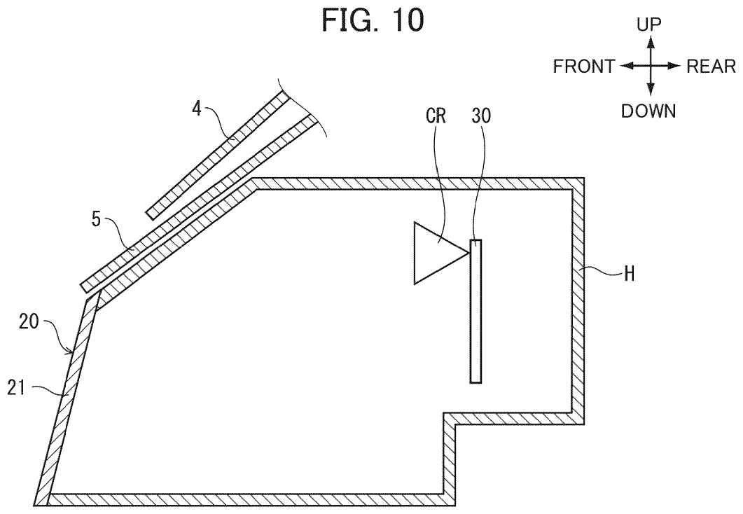

FIG. 10 is a sectional view illustrating a disposition relationship between the substrate 30 and the corner reflector CR according to a third modification of the present invention. The corner reflector CR can be integrated with the substrate 30 or can be coupled to the substrate 30 via a metal member. In this manner, it is possible to use the corner reflector CR as a heat dissipation member and to curb a heat increase of the substrate 30.

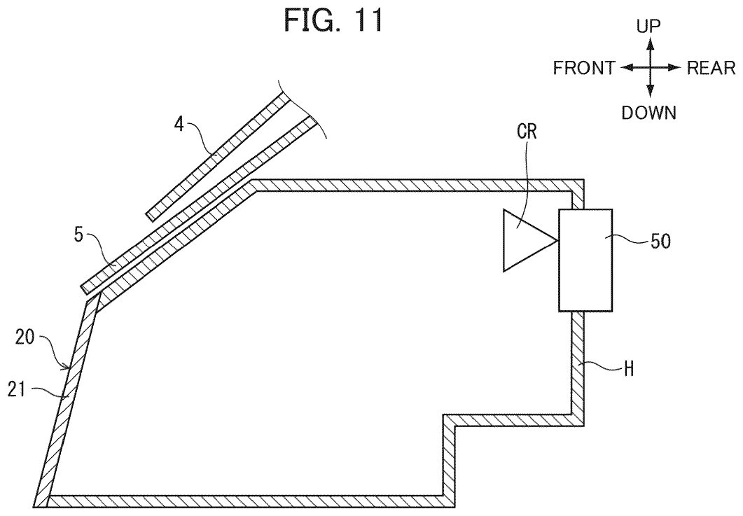

FIG. 11 is a sectional view illustrating a disposition relationship between a heat sink 50 and the corner reflector CR according to the second embodiment of the present invention. In the present embodiment, the heat sink 50 that dissipates heat generated by the substrate 30 is provided at a rear end of a housing H, and the corner reflector CR is integrated with the heat sink 50 or is coupled to the heat sink 50 via a metal member. In this manner, it is possible to use the corner reflector CR as a heat dissipation member and to curb a heat increase of the heat sink 50.

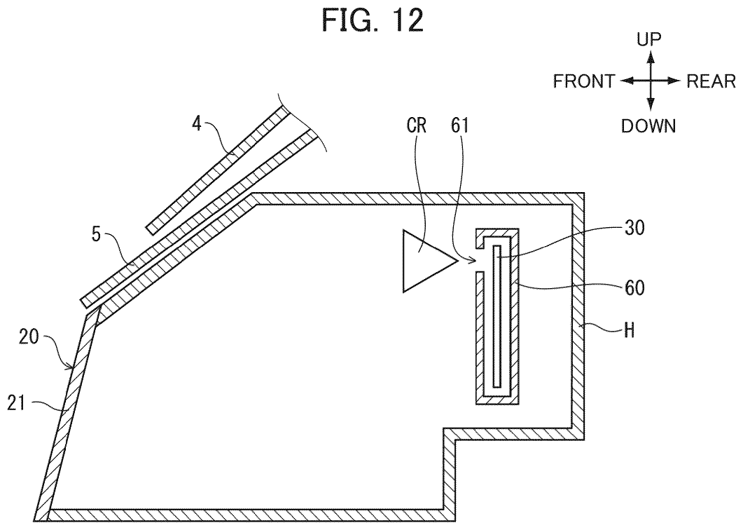

FIG. 12 is a sectional view illustrating a disposition relationship between a noise shield 60 and a corner reflector CR according to a third embodiment of the present invention. The noise shield 60 formed of a synthetic resin or the like covers at least a part of a substrate 30 in order to curb dissipation of noise generated from the substrate 30. The present embodiment is characterized in that the noise shield 60 has an opening 61 in a front portion thereof and the corner reflector CR is disposed in front of the opening 61. In this manner, it is possible to block noise of the substrate 30 dissipated forward from the opening 61 of the noise shield 60 with the corner reflector CR.

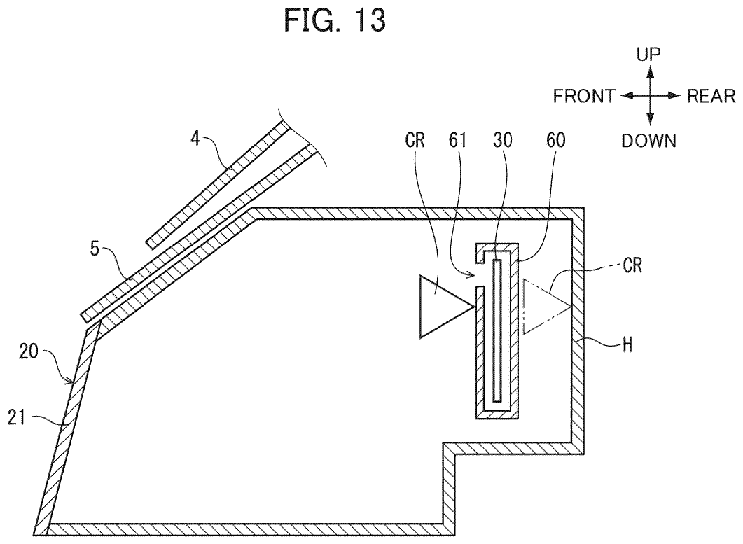

FIG. 13 is a sectional view illustrating a disposition relationship between the noise shield 60 and the corner reflector CR according to a modification of the third embodiment of the present invention. The present modification is characterized in that the corner reflector CR is integrated with the noise shield 60 or is coupled to the noise shield 60 via a stay member. In this manner, it is possible to eliminate necessity of a member supporting the corner reflector CR or to reduce the size of the member. Note that the corner reflector CR can also be disposed behind the noise shield 60.

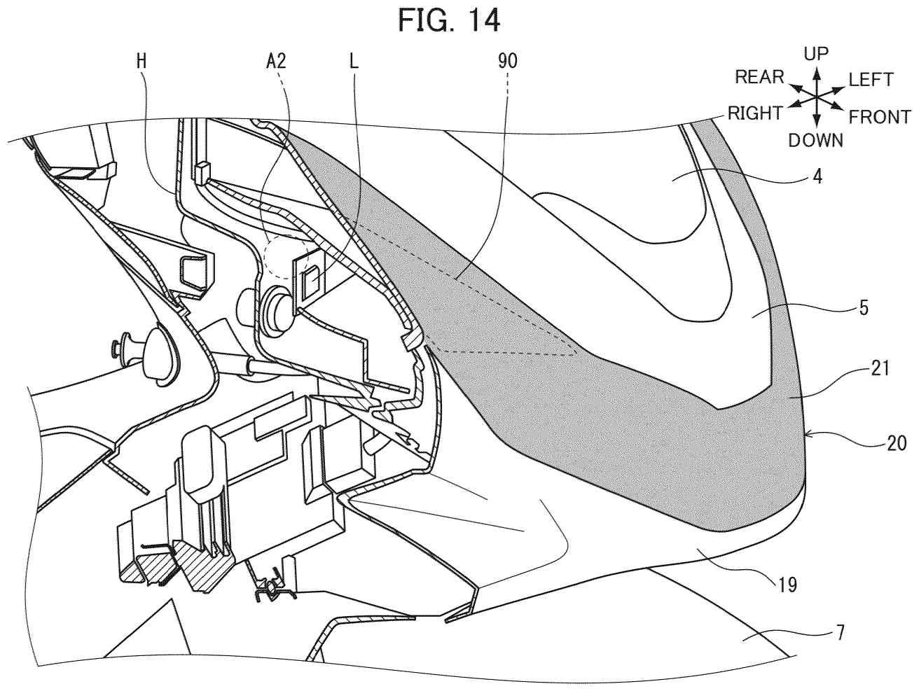

FIG. 14 is a perspective view illustrating a corner reflector installation structure for a corner reflector CR according to a fourth embodiment of the present invention. The present embodiment is characterized in that a light guiding member 90 that emits light from its entire body by causing irradiation light from a light source L to be incident thereon and is made of clear transparent or colored transparent polycarbonate resin or the like is disposed behind an outer lens 21 and the corner reflector CR is disposed behind the light guiding member 90. In order to cause the irradiation light to be incident on the light guiding member 90, it is necessary to secure a distance between the light source L and the light guiding member 90 to some extent, and a space is thus generated behind the light guiding member 90. In the present embodiment, the corner reflector CR is disposed by effectively using the space behind the light guiding member 90. Although an example of the position where the corner reflector CR is installed is illustrated by the dashed-line circle A2 in this drawing, it is possible to select a position from various positions deviating from the dashed-line circle A2 in front-back, up-down, and left-right directions as long as the corner reflector CR is located behind the light guiding member 90 and does not overlap with an optical axis of the light source L at the positions.

Note that the form of the motorcycle, the shape and the structure of the headlight, the shape and the structure of the corner reflector, the disposition positions and the number of corner reflectors, the shape and the disposition of the substrate, the shape and the disposition of the noise shield, the shape and the disposition of the heat sink, and the like are not limited to those in the above embodiments, and various modifications can be made. For example, the corner reflector installation structure described above may be applied to a rear position lamp device disposed at a rear portion of the vehicle body. The corner reflector installation structure according to the present invention can be applied to various two-wheeled vehicles, three-wheeled vehicles, and four-wheeled vehicles having lamps.

### EXPLANATION OF REFERENCE NUMERALS

1 . . . Motorcycle (vehicle), 5 . . . Front cowl (cover member), 13 . . . Rear position lamp device (lamp), 19 . . . Coupling cowl (cover member), 20 . . . Headlight (lamp), 30 . . . Substrate, 50 . . . Heat sink, 60 . . . Noise shield, 61 . . . Opening of noise shield, CR . . . Corner reflector, H . . . Housing, h . . . Height dimension of substrate, w . . . Width dimension of substrate

What is claimed is:

1. A corner reflector installation structure that is applicable to a vehicle including a lamp; a cover member that covers a part of the lamp; and a corner reflector, wherein
the corner reflector is provided inside a housing constituting the lamp, and
the corner reflector installation structure is configured such that the cover member and the corner reflector overlap with each other in a front view of a vehicle body of the vehicle.

2. The corner reflector installation structure according to claim 1, wherein
the cover member is inclined such that a vehicle body upper side of the cover member is located backward relative to a vehicle body lower side of the cover member in a side view of the vehicle.

3. The corner reflector installation structure according to claim 1, wherein
the cover member is inclined such that a vehicle body lower side of the cover member is located backward relative to a vehicle body upper side of the cover member in a side view of the vehicle.

4. The corner reflector installation structure according to claim 1, wherein
a substrate on which components including metal are mounted is provided inside the housing, and
the corner reflector is installed such that the corner reflector does not overlap with the substrate and partially overlaps with an outside of a range of a height dimension of the substrate in a front view of the vehicle body.

5. The corner reflector installation structure according to claim 1, wherein
a substrate on which components including metal are mounted is provided inside the housing, and
the corner reflector is installed such that the corner reflector does not overlap with the substrate and is within a range of a height dimension of the substrate in a front view of the vehicle body.

6. The corner reflector installation structure according to claim 1, wherein
a substrate on which components including metal are mounted is provided inside the housing, and
the corner reflector is installed such that the corner reflector does not overlap with the substrate and partially overlaps with an outside of a range of a width dimension of the substrate in a front view of the vehicle body.

7. The corner reflector installation structure according to claim 1, wherein
a substrate on which components including metal are mounted is provided inside the housing, and
the corner reflector is installed such that the corner reflector does not overlap with the substrate and is within a range of a width dimension of the substrate in a front view of the vehicle body.

8. The corner reflector installation structure according to claim 1, wherein
a substrate on which components including metal are mounted is provided inside the housing, and
the corner reflector is disposed forward relative to the substrate.

9. The corner reflector installation structure according to claim 1, wherein
a substrate on which components including metal are mounted is provided inside the housing, and
the corner reflector is integrated with the substrate or is coupled to the substrate via a metal member.

10. The corner reflector installation structure according to claim 1, wherein
the lamp has a heat sink, and
the corner reflector is integrated with the heat sink or is coupled to the heat sink via a metal member.

11. The corner reflector installation structure according to claim 1, wherein
a substrate on which components including metal are mounted is provided inside the housing,
a noise shield covers at least a part of the substrate,
the noise shield has an opening in a front portion thereof, and
the corner reflector is disposed in front of the opening.

12. The corner reflector installation structure according to claim 1, wherein
a substrate on which components including metal are mounted is provided inside the housing,
a noise shield covers at least a part of the substrate, and
the corner reflector is integrated with the noise shield or is coupled to the noise shield via a stay member.

13. The corner reflector installation structure according to claim 1, wherein
a light guiding member that emits light from an entire body thereof by causing irradiation light from a light source to be incident thereon is provided inside the housing, and
the corner reflector is provided behind the light guiding member.
